(19) United States
(12) Patent Application Publication
(10) Pub. No.: US 2012/0326820 A1
(43) Pub. Date: Dec. 27, 2012

(54) MAGNETIC UNIT

(75) Inventors: Cheng-Han YU, TAOYUAN HSIEN (TW); Yu-Chun LAI, TAOYUAN HSIEN (TW); Hsin-Wei Tsai, TAOYUAN HSIEN (TW)

(73) Assignee: DELTA ELECTRONICS, INC., TAOYUAN HSIEN (TW)

(21) Appl. No.: 13/480,463

(22) Filed: May 24, 2012

(30) Foreign Application Priority Data
Jun. 24, 2011 (TW) 100122125

(51) Int. Cl. H01F 3/00

(52) U.S. Cl. 335/297

(57) ABSTRACT

The disclosure discloses a magnetic unit, which includes a first ferrite core component, a second ferrite core component and a winding. There is a first hollow portion within the first ferrite core component. The second ferrite core component is disposed in the first hollow portion. There is a second hollow portion within the second ferrite core component. Magnetic saturation characteristics of the second ferrite core component are better than magnetic saturation characteristics of the first ferrite core component. The winding is wound on the first ferrite core component and the second ferrite core to component.

### RELATED APPLICATIONS

This application claims priority to Taiwan Application Serial Number 100122125, filed Jun. 24, 2011, which is herein incorporated by reference.

### BACKGROUND

1. Technical Field

The present disclosure relates to a magnetic unit. More particularly, the present disclosure relates to a magnetic unit with circular cores.

2. Description of Related Art

Magnetic units, e.g., transformers, inductors and choke coils, may generate a magnetic field when currents go through the magnetic units. The magnetic units are mainly formed by a ferrite core and a winding. The magnetic units are widely applied in circuits with high current or high power features.

To achieve portability and practicality, modern electronic products are lightweight and small in size. Electronic products, such as computers, servers and LCD televisions, must be assembled in a compact structure for modern applications. In order to optimize structure, improve efficiency and reduce the cost of electronic products, much effort is being put forth in the industry with respect to aspects of hardware design, manufacturing and assembly. In keeping with the trend in modern electronic products for compact design, the magnetic units inside such electronic products must be made having a small size.

Furthermore, magnetic units are often custom-designed in order to correspond to different electromagnetic characteristic demands (e.g., inductance characteristics) for different applications. When the electromagnetic characteristics of a traditional magnetic unit do not match a particular circuit application, the traditional magnetic unit may be altered to realize the required electromagnetic characteristics by stacking multiple ferrite cores of the same size, replacing the original ferrite core with a bigger ferrite core, or increasing the number of winding coils. Therefore, the total layout block space of a traditional magnetic unit on a printed circuit board (PCB) increases. If a traditional magnetic unit extends past an allowable range on a PCB, the circuit layout would have to be partially reallocated or fully re-designed. Changes to the inductance component or magnetic unit may require re-designing the circuit, re-producing the printed circuit board and re-producing a new mold, so that such changes may require much time to undertake and involve significant costs.

### SUMMARY

In order to solve the aforesaid problem, this disclosure provides a magnetic unit, which includes at least two circular ferrite core components, in which one of the ferrite core components is disposed in the other ferrite core component. The aforesaid compound core structure including the two ferrite core components may have various combinations in material, thickness, inner diameter and outer diameter. In this way, the electromagnetic characteristics of the magnetic unit can be adjusted (e.g., the electromagnetic conversion efficiency may be elevated) without changing the number of turns of a winding. Therefore, the compound core structure may reduce the total length of the winding, and cut the overall cost and minimize the size of the magnetic unit.

An aspect of the disclosure is to provide a magnetic unit, which includes a first ferrite core component, a second ferrite core component and a winding. The first ferrite core component has a first hollow portion therewithin. The second ferrite core component is disposed in the first hollow portion. The second ferrite core component has a second hollow portion therewithin. Magnetic saturation characteristics of the second ferrite core component are better than magnetic saturation characteristics of the first ferrite core component. The winding is wound on the first ferrite core component and the second ferrite core component.

According to an embodiment of this disclosure, the winding is wound on the first ferrite core component and the second ferrite core component by extending from a side surface of the first ferrite core component, then along a side surface of the second ferrite core component, an inner circular surface of the second ferrite core component, another side surface of the second ferrite core component and another side surface of the first ferrite core component, and then to an outer circular surface of the first ferrite core component. In this embodiment, the second ferrite core component can be fixed within the first hollow portion of the first ferrite core component by the winding.

According to an embodiment of this disclosure, each of the first ferrite core component and the second ferrite core component is formed substantially in a ring shape.

According to an embodiment of this disclosure, an inductance declination of the second ferrite core component is less than an inductance declination of the first ferrite core component when a load current applied thereto is increased.

According to an embodiment of this disclosure, a saturation magnetic flux density of the second ferrite core component is greater than a saturation magnetic flux density of the first ferrite core component.

According to an embodiment of this disclosure, the first ferrite core component includes a material selected from the group consisted of Kool Mu® powder and iron powder.

According to an embodiment of this disclosure, the second ferrite core component includes a material selected from the group consisted of molypermalloy powder (MPP) and HIGH-FLUX powder.

According to an embodiment of this disclosure, a first air gap is formed in the first ferrite core component, and the second ferrite core component has a corresponding area near the first air gap. The first air gap can be utilized to increase a permeability (μ) on the corresponding area of the second ferrite core component.

According to an embodiment of this disclosure, a second air gap is formed in the second ferrite core component, and the first ferrite core component has a corresponding area near the second air gap. The second air gap can be utilized to increase a permeability on the corresponding area of the second ferrite core component.

### BRIEF DESCRIPTION OF THE DRAWINGS

The disclosure can be more fully understood by reading the following detailed description of the embodiment, with reference made to the accompanying drawings as follows:

FIG. 1 is an exploded diagram illustrating a magnetic unit according to a first embodiment of the disclosure;

FIG. 2 is a perspective view illustrating the magnetic unit in FIG. 1 after assembly;

FIG. 3 is a perspective view of a magnetic unit according to a second embodiment of the disclosure, in which an air gap is formed in a first ferrite core component of the magnetic unit; and

FIG. 4 is a perspective view of a magnetic unit according to a third embodiment of the disclosure, in which an air gap is formed in a second ferrite core component of the magnetic unit.

### DETAILED DESCRIPTION

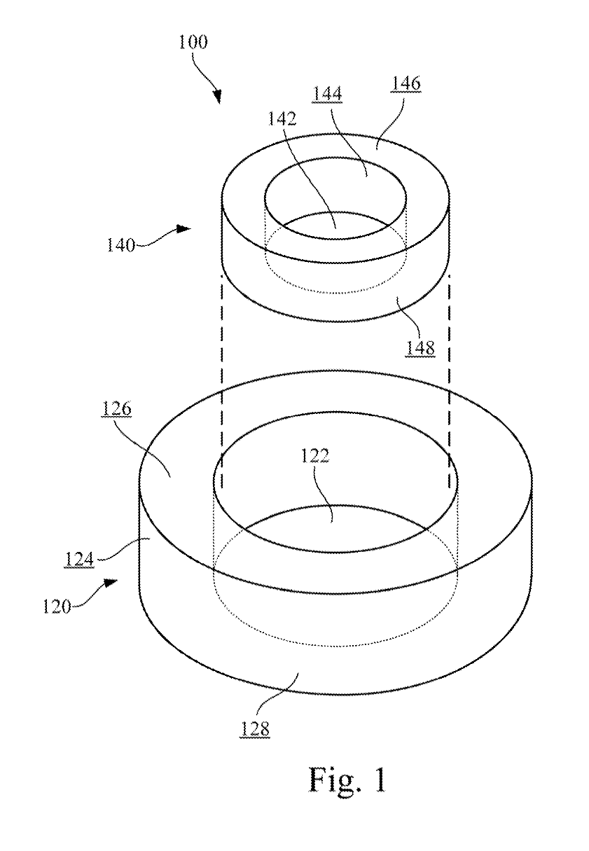

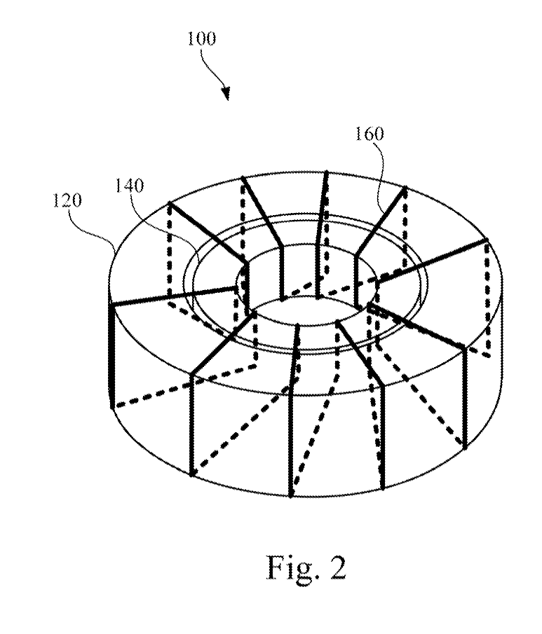

FIG. 1 is an exploded diagram illustrating a magnetic unit 100 according to a first embodiment of the disclosure. FIG. 2 is a perspective view illustrating the magnetic unit 100 in FIG. 1 after assembly.

As shown in FIG. 1, the magnetic unit 100 includes a first ferrite core component 120 and a second ferrite core component 140. In this embodiment, the first ferrite core component 120 has a first hollow portion 122. The second ferrite core component has a second hollow portion 142. Each of the first ferrite core component 120 and the second ferrite core component 140 is formed substantially in a ring shape and has an inner diameter and an outer diameter. In the example of FIG. 1, the first ferrite core component 120 and the second ferrite core component 140 form a set of concentric rings with a longer radius and a shorter radius respectively. The outer diameter of the second ferrite core component 140 is designed to be slightly shorter than or equal to the inner diameter of the first ferrite core component 120, such that the second ferrite core component 140 can be accommodated in the first hollow portion 122 of the first ferrite core component 120.

As shown in FIG. 2, the magnetic unit 100 further includes a winding 160 (not shown in FIG. 1). When the second ferrite core component 140 is allocated in the first ferrite core component 120, the winding 160 is wound on both of the first ferrite core component 120 and the second ferrite core component 140.

As shown in FIG. 2, each turn of the winding 160 is wound over the outer first ferrite core component 120 and the inner second ferrite core component 140. As shown in FIG. 1 and FIG. 2, the winding 160 in the embodiment is started from the upper side surface 126 of the first ferrite core component 120, then extends along the upper side surface 146 of the second ferrite core component 140, the inner circular surface 144 of the second ferrite core component 140, the lower side surface 148 of the second ferrite core component 140 and the lower side surface 128 of the first ferrite core component 120, and then is wound over the outer circular surface 124 of the first ferrite core component 120. Hence, the winding 160 is wound on the first ferrite core component 120 and the second ferrite core component 140. In this embodiment, the second ferrite core component 140 is held by the winding 160, so as to be fixed within the first hollow portion 122 of the first ferrite core component 120.

It is to be noted that there is only one ferrite core within the winding in the structure of a traditional magnetic unit. To adjust or change the magnetic characteristics of the traditional magnetic unit, the material or the size of the ferrite core needs to be re-designed or re-modeled. In this embodiment of the disclosure, the magnetic unit 100 of the disclosure has the first ferrite core component 120 and the second ferrite core component 140. The first ferrite core component 120 and the second ferrite core component 140 can be formed with different material characteristics. For example, the first ferrite core component 120 and the second ferrite core component 140 may have different magnetic saturation characteristics, so that the equivalent magnetic properties of the whole ferrite core can be adjusted easily by selecting a combination of magnetic saturation characteristics of the two ferrite core components 120, 140. As a result, costs related to re-designing or re-modeling the ferrite core in the traditional magnetic unit can be saved.

The aforesaid compound core structure including the two ferrite core components 120, 140 may have various combinations in material, thickness, inner diameter and outer diameter. In this way, the electromagnetic characteristics of the magnetic unit 100 can be adjusted without changing the number of turns of the winding 160.

In the embodiment, magnetic saturation characteristics of the second ferrite core component 140 can be configured to be better than magnetic saturation characteristics of the first ferrite core component 120. A common characteristic of ferrite core materials is such that the inductance (also known as the L value) of a ferrite core will decline when a load current applied to the ferrite core is increased. Better magnetic saturation characteristics mentioned above may mean that the inductance declination of the second ferrite core component 140 is less than the inductance declination of the first ferrite core component 120 when a load current applied thereto is increased. In other words, the second ferrite core component 140 has a higher tolerance to large load current. Or in another embodiment, better magnetic saturation characteristics mentioned above may mean that the saturation magnetic flux density (Bs) of the second ferrite core component 140 is greater than the saturation magnetic flux density of the first ferrite core component 120.

In the embodiment, the material of the second ferrite core component 140 can be selected from the group consisted of molypermalloy powder (MPP) and HIGH-FLUX powder. The material of the first ferrite core component 120 can be selected from the group consisted of Kool Mu powder and iron powder. Based on the aforesaid selection of materials, the second ferrite core component 140 may have better magnetic saturation characteristics over the first ferrite core component 120, but the disclosure is not limited to the materials in the example above.

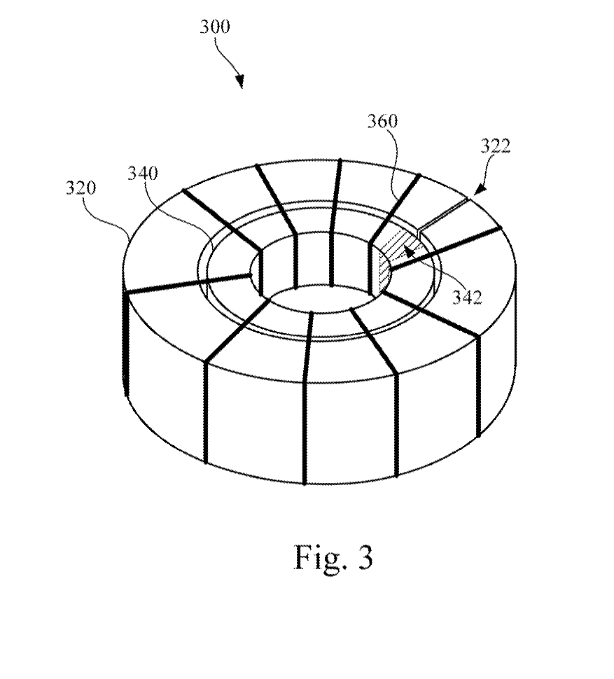

FIG. 3 is a perspective view of a magnetic unit 300 according to a second embodiment of the disclosure, in which an air gap 322 is formed in a first ferrite core component 320 of the magnetic unit 300.

As shown in FIG. 3, the magnetic component 300 includes a first ferrite core component 320, a second ferrite core component 340 and a winding 360. The first ferrite core component 320 and the second ferrite core component 340 are formed substantially in a ring shape. The second ferrite core component 340 is allocated in the first ferrite core component 320. Magnetic saturation characteristics of the second ferrite core component 340 may be better than magnetic saturation characteristics of the first ferrite core component 320. The winding 360 is wound on the first ferrite core component 320 and the second ferrite core component 340.

In the second embodiment, there is an air gap 322 formed in the first ferrite core component 320. The second ferrite core component has a corresponding area 342 near the air gap 322. The air gap 322 can be utilized to increase the permeability (μ) of the corresponding area 342 of the second ferrite core component 340.

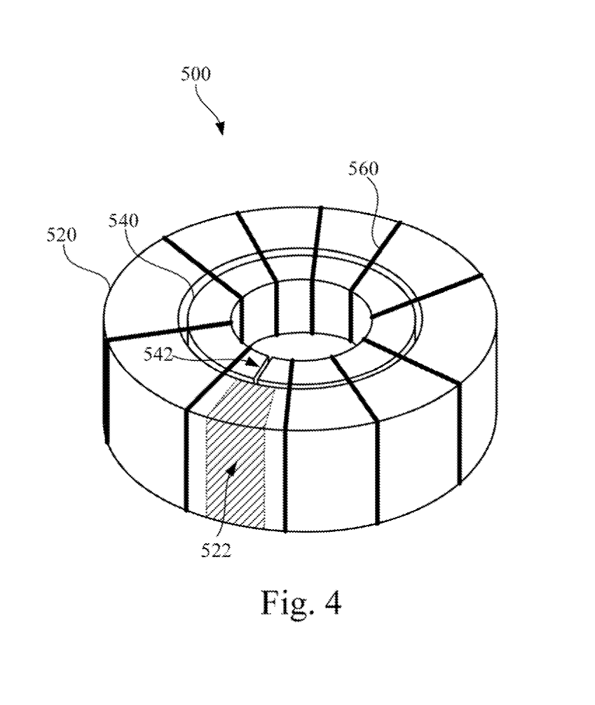

FIG. 4 is a perspective view of a magnetic unit 500 according to a third embodiment of the disclosure, in which an air gap 542 is formed in a second ferrite core component 540 of the magnetic unit 500.

As shown in FIG. 4, the magnetic unit 500 includes a first ferrite core component 520, a second ferrite core component 540 and a winding 560. In the third embodiment, an air gap 542 is formed in the second ferrite core component 540. The first ferrite core component 520 has a corresponding area 522 near the air gap 542. The air gap 542 can be utilized to increase the permeability (μ) of the corresponding area 522 of the first ferrite core component 520.

It is to be noted that the disclosure is not limited to the formation of one air gap, nor with respect to in which ferrite core the air gap(s) is formed. In practical applications, one or more air gaps can be formed in different parts of the first or second ferrite core component depending on actual requirements.

This disclosure provides a magnetic unit, which includes at least two circular ferrite core components, in which one of the ferrite core components is disposed in the other ferrite core component. The compound core structure including the two ferrite core components may have various combinations in material, thickness, inner diameter and outer diameter. In this way, the electromagnetic characteristics of the magnetic unit can be adjusted (e.g., the electromagnetic conversion efficiency may be elevated) without changing the number of turns of the winding. Therefore, the compound core structure may reduce the total length of the winding, and cut the overall cost and minimize the size of the magnetic unit.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A magnetic unit, comprising:
a first ferrite core component having a first hollow portion therewithin;
a second ferrite core component disposed in the first hollow portion, the second ferrite core component having a second hollow portion therewithin, magnetic saturation characteristics of the second ferrite core component being better than magnetic saturation characteristics of the first ferrite core component; and
a winding wound on the first ferrite core component and the second ferrite core component.

2. The magnetic unit of claim 1, wherein the winding is wound on the first ferrite core component and the second ferrite core component by extending from a side surface of the first ferrite core component, then along a side surface of the second ferrite core component, an inner circular surface of the second ferrite core component, another side surface of the second ferrite core component and another side surface of the first ferrite core component, and then to an outer circular surface of the first ferrite core component.

3. The magnetic unit of claim 2, wherein the second ferrite core component is fixed within the first hollow portion of the first ferrite core component by the winding.

4. The magnetic unit of claim 1, wherein each of the first ferrite core component and the second ferrite core component is formed substantially in a ring shape.

5. The magnetic unit of claim 1, wherein an inductance declination of the second ferrite core component is less than an inductance declination of the first ferrite core component when a load current applied thereto is increased.

6. The magnetic unit of claim 1, wherein a saturation magnetic flux density of the second ferrite core component is greater than a saturation magnetic flux density of the first ferrite core component.

7. The magnetic unit of claim 1, wherein the first ferrite core component comprises a material selected from the group consisted of Kool Mu powder and iron powder.

8. The magnetic unit of claim 1, wherein the second ferrite core component comprises a material selected from the group consisted of molypermalloy powder (MPP) and HIGH-FLUX powder.

9. The magnetic unit of claim 1, wherein a first air gap is formed in the first ferrite core component, and the second ferrite core component has a corresponding area near the first air gap.

10. The magnetic unit of claim 1, wherein a second air gap is formed in the second ferrite core component, and the first ferrite core component has a corresponding area near the second air gap.
